(19) United States
(12) Patent Application Publication
(10) Pub. No.: US 2008/0155148 A1
(43) Pub. Date: Jun. 26, 2008

(54) Cooperative communication of data

(76) Inventor: Ozgur Oyman, Palo Alto, CA (US)

Correspondence Address: LEE & HAYES, PLLC;c/o Intellevate, LLC, P.O. BOX 52050, MINNEAPOLIS, MN, 55402, US

(21) Appl. No.: 11/588,899

(22) Filed: Oct. 26, 2006

(51) Int. Cl. G06F 13/42

(52) U.S. Cl. 710/106

(57) ABSTRACT

Embodiments of cooperative communication of data are presented herein.

### BACKGROUND

Wireless data communication networks are often subject to slow fading. Slow fading occurs when the signal propagation environment changes slowly relative to the data communication rate. Slow fading may also be defined as the situation where the communication channel coherence time is larger than several frame durations. Communication problems occur as a result of slow fading because the receiving device typically has a strict decoding delay constraint, especially in the case of voice and audio transmission.

In a slow fading environment, a burst of errors will significantly degrade the data communication performance and negatively impact the reliable decoding of the transmitted data. If the communication system can tolerate a certain amount of delay, the erroneous data can be retransmitted using an automatic repeat request (ARQ) protocol. Various ARQ protocols are available to prevent (or reduce), for each communication link, the loss of frames due to transmission errors. However, in certain situations, existing ARQ protocols are not sufficient to enhance communication link reliability. For example, when a deep fade is experienced by a communication link between a transmitter and a receiver, existing ARQ protocols may not improve the communication link quality.

### BRIEF DESCRIPTION OF THE DRAWINGS

FIGS. 1A and 1B illustrate an example environment that communicates data between a source device and a destination device.

FIG. 2 is an illustration of an example environment in which two computing devices communicate data with one another.

FIG. 3 is a flow diagram depicting an example procedure for communicating data between two devices.

FIG. 4 is an illustration of an example environment containing a source device, a cooperating device, and a destination device.

The same reference numbers are utilized in instances in the discussion to reference like structures and components.

### DETAILED DESCRIPTION

In the following discussion, exemplary devices are described which may provide and/or utilize techniques to communicate data between two or more devices. One or more cooperating devices are provided to assist with the communication of data, thereby improving the quality of the data transmission. For example, cooperating devices are used to retransmit data to a destination device using a better quality communication link when the original data transmission failed. Different encoding schemes may be used by a source device and an associated cooperating device to provide enhanced coding gain. Exemplary procedures are described which may be employed by the exemplary devices, as well as by other devices without departing from the spirit and scope thereof.

As used herein, the terms “cooperating device”, “cooperator device”, and “relay device” are interchangeable.

Exemplary Devices

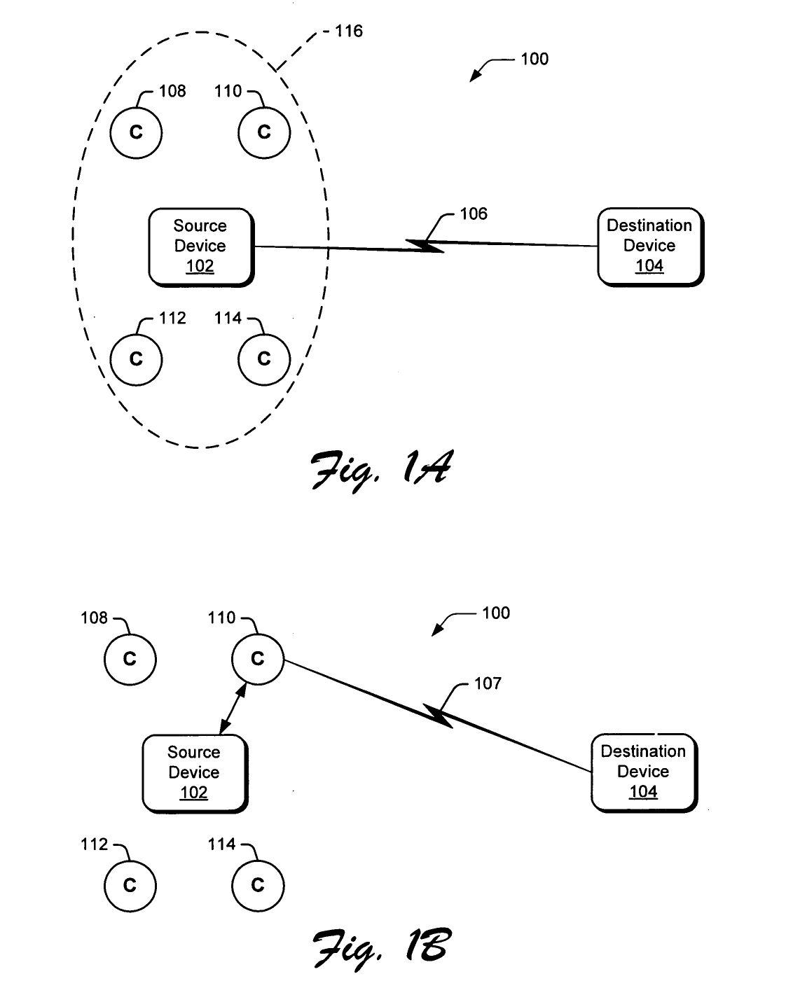

FIGS. 1A and 1B illustrate an example environment 100 that communicates data between a source device and a destination device. Environment 100 includes a source device 102 that communicates with a destination device 104 via a wireless communication link 106. Any communication protocol can be used to communicate data between source device 102 and destination device 104. Additionally, any encoding scheme (e.g., error correction coding or network coding) can be used to encode the communicated data. Several cooperating devices 108, 110, 112, and 114 are located in the vicinity of source device 102. Source device 102 is capable of communicating data with each cooperating device 108, 110, 112, and 114 and each cooperating device is capable of communicating data with destination device 104 via separate wireless communication links (not shown in FIG. 1A). The combination of source device 102 and cooperating devices 108, 110, 112, and 114 is referred to as a “transmit cluster” and identified by reference numeral 116. Alternatively, the cooperating devices 108, 110, 112, and 114 are said to be “associated with” source device 102.

As discussed herein, source device 102 is capable of communicating with each cooperating device 108, 110, 112, and 114, and using one or more of the cooperating devices to assist with the communication of data to and from destination device 104. Although four cooperating devices 108, 110, 112, and 114 are shown in FIG. 1A, a particular environment 100 may include any number of cooperating devices. Further, a particular transmit cluster 116 may contain any number of source devices 102 associated with any number of cooperating devices.

FIG. 1B illustrates environment 100 after an alternate communication link has been established to communicate data from source device 102 to destination device 104. In the example of FIG. 1B, source device 102 has selected cooperating device 110 to retransmit data to destination device 104 via a different wireless communication link 107 if the initial transmission of the data from source device 102 to destination device 104 fails. Cooperating device 110 was selected by source device 102 because cooperating device 110 had the preferred (among the four cooperating devices 108, 110, 112, and 114) communication link to destination device 104. Additional details regarding the selection of cooperating devices and the retransmission of data are provided below.

The embodiment shown in FIGS. 1A and 1B illustrate multiple cooperating devices 108, 110, 112, and 114 associated with source device 102 to form a transmit cluster 116. In other embodiments, one or more cooperating devices are associated with destination device 104 to form a receive cluster. The cooperating devices provide an alternate data transmission link from source device 102 to destination device 104. Additional details regarding the operation of such embodiment are provided herein.

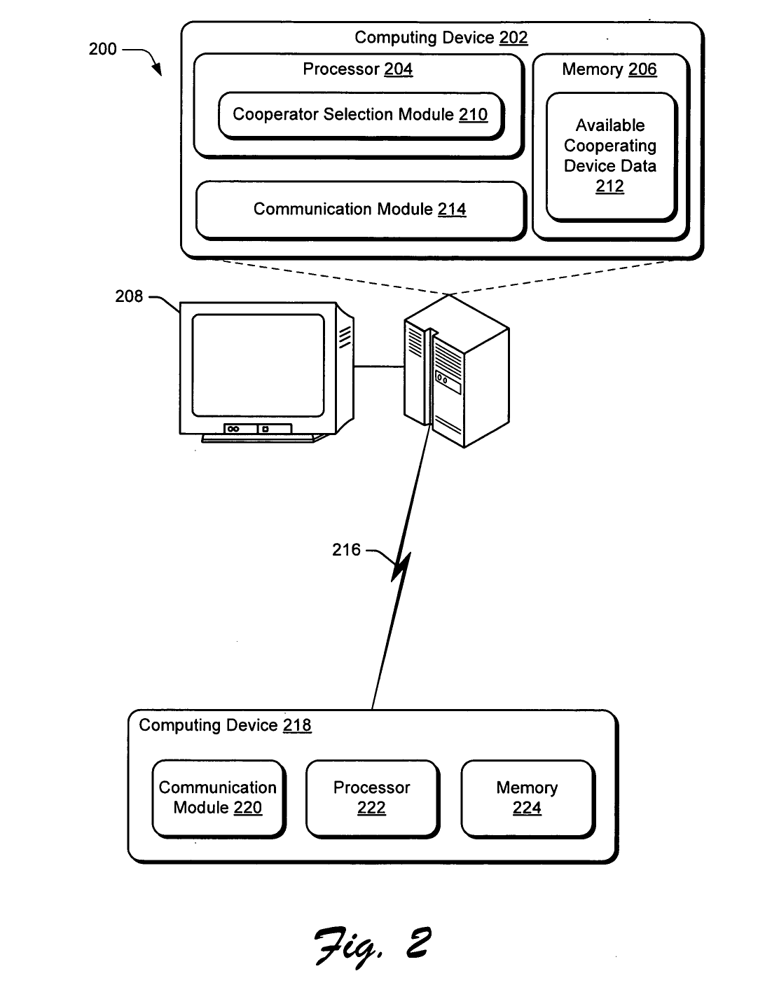

FIG. 2 is an illustration of an example environment 200 in which two computing devices communicate data with one another. Environment 200 includes a first computing device 202 and a second computing device 218, both of which are operable to employ the techniques to communicate data described herein. Computing devices 202 and 218 may be configured in a variety of ways, such as a traditional desktop computers (e.g., desktop PCs), servers, notebook computers, personal information appliances, data communication cards, and so on. Each computing device 202 and 218 may be configured independently of the other computing device. Thus, computing devices 202 and 218 may be configured as “thick” computing devices having significant processing and memory resources (e.g., servers) to “thin” computing devices having relatively limited processing and/or memory resources, such as personal information appliances. A wide variety of other configurations are also contemplated.

Computing device 202, as illustrated in FIG. 2, includes a processor 204, memory 206, and an output device, which is illustrated as a display device 208 in FIG. 2, but may assume a wide variety of other configurations, such as a network interface. Display device 208 is communicatively coupled to processor 204 via a bus, such as a host bus of a graphics memory controller hub. Processor 204 can be configured in a variety of ways, and thus, is not limited by the materials from which it may be formed or the processing mechanisms employed therein. For example, processor 204 may be comprised of semiconductor(s) and/or transistors (e.g., electronic integrated circuits (ICs)), and so on. Additionally, although a single processor 204 is illustrated, processor 204 may be representative of multiple processors that are communicatively coupled to memory 206 through use of a bus.

Memory 206 may be representative of “main memory” of computing device 202, persistent storage (e.g., a hard disk drive), removable computer-readable media (e.g., a digital video disc (DVD)), and other types of computer-readable media. Likewise, although a single memory 206 is illustrated, memory 206 may be representative of multiple memory devices, such as dynamic random access memory (DRAM) and a hard disk drive. A variety of other implementations are also contemplated.

Computing device 202 includes a cooperator selection module 210 that is capable of selecting a cooperating device for use in retransmitting data from computing device 202. For example, cooperator selection module 210, when executed, analyzes the various available cooperating devices and identifies the cooperating device having the preferred communication link (among the available cooperating devices) to a particular destination device. Additionally, cooperator selection module 210 can grant communication authorization to the identified cooperating device, as discussed herein.

Various available cooperating device data 212 is maintained in memory 206. This cooperating device data 212 is used, for example, by cooperator selection module 210 to analyze the various cooperating devices. Cooperating device data 212 may include information associated with the quality of communication links between various cooperating devices and a particular destination device.

Computing device 202 also includes a communication module 214, which allows computing device 202 to communicate with any number of devices via any number of communication links and/or communication networks. For example, the communication module 214 may utilize an antenna (e.g., a dipole antenna, multiple antennas, and so on) to wireless communicate with other devices. In the example of FIG. 2, communication module 214 communicates with computing device 218 via a wireless communication link 216. Communication module 214 may use any communication protocol to communicate with computing device 218.

Computing device 218 includes a communication module 220, a processor 222, and a memory 224. Communication module 220 allows computing device 218 to communicate with other devices, such as other computing devices. Processor 222 and memory 224 may be similar to processor 204 and memory 206 discussed above, and may operate in a similar manner. In a particular embodiment, computing device 218 contains a cooperator selection module 210 of the type contained in computing device 202.

In one embodiment, cooperating devices have components similar to those shown in computing device 218. Cooperating devices utilize a communication module to communicate with other devices, such as source devices and destination devices. Additionally, cooperating devices include a processor for executing various instructions and a memory for storing data.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs such as the processors 204 and 222 of FIG. 2). The program code can be stored in one or more computer-readable memory devices, e.g., memories 206 and 224 of FIG. 2. The techniques of selecting alternate cooperating devices and providing retransmission of data from a cooperating device as described herein are platform-independent, meaning that the techniques may be implemented on a variety of commercial computing platforms having a variety of processors.

Exemplary Procedures

The following discussion describes data communication techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

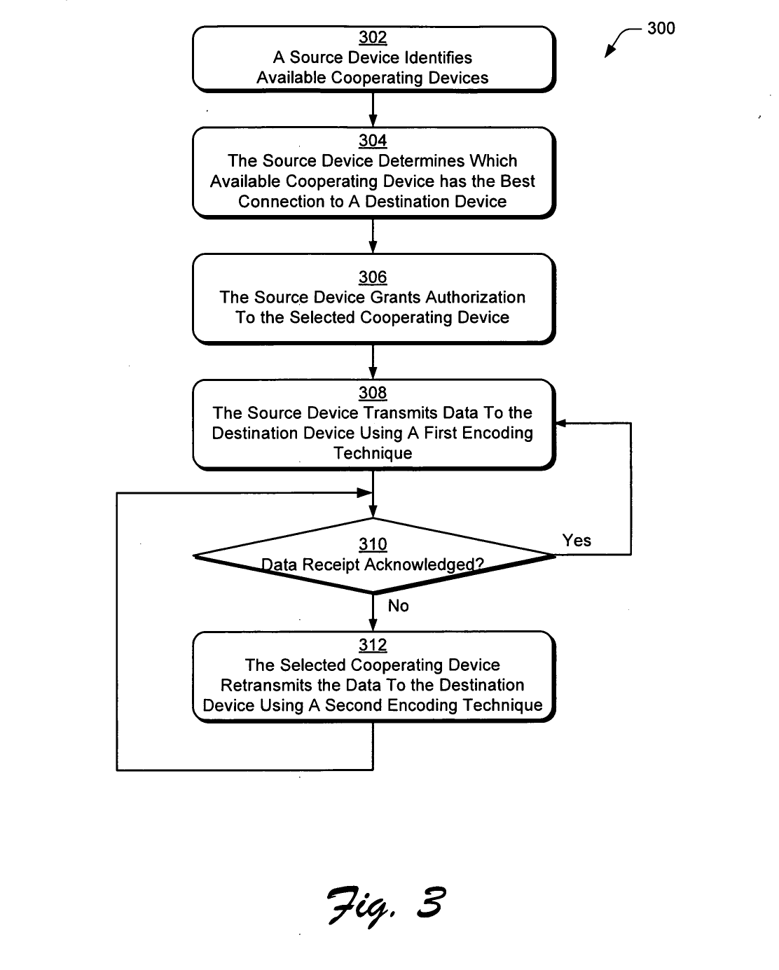

FIG. 3 is a flow diagram depicting an example procedure 300 for communicating data between two devices. Initially, a source device identifies available cooperating devices (block 302). For example, a source device may identify available cooperating devices associated with the source device or contained in the same transmit cluster as the source device. The source device then determines which available cooperating device has the preferred connection to a destination device (block 304). In a particular embodiment, this determination is performed by calculating an expected transmission time (ETT) metric for each available cooperating device. The cooperating device with the lowest ETT value is selected as having the preferred connection to the destination device. The source device may not designate a cooperating device if none of the candidate devices have a better channel (e.g., a lower ETT) to the destination device than itself. In this situation, the mechanism operates in a standard manner. The ETT measures the expected transmission time associated with a particular communication link, such as the communication link between a particular cooperating device and a particular destination device. The ETT metric is defined as the reciprocal of the expected throughput. In alternate embodiments, various other metrics are used to identify the cooperating device with the preferred connection to the destination device.

After a cooperating device is selected at block 304, the source device grants authorization to the selected cooperating device (block 306). When the selected cooperating device is granted this authorization, the selected cooperating device begins monitoring data transmissions by the source device. The source device then transmits data to the destination device using a first encoding technique (block 308).

Procedure 300 continues by determining whether the destination device has acknowledged receipt of the data transmitted by the source device (block 310). For example, data may be examined by the destination device using an error detection procedure, such as a cyclic redundancy check (CRC). If the data passes the CRC, the destination device sends an acknowledgement (ACK) of successful transmission to the source device. If the data does not pass the CRC (i.e., the destination device detects one or more errors in the received data), the destination device sends a negative acknowledgement (NACK) and requests retransmission of the data. User data and CRC bits may be additionally protected by an error correcting code which increases the probability of successful transmission. In Hybrid ARQ (HARQ) protocols, error detection and correction are combined in order to obtain better reliability and throughput.

If receipt of the data is acknowledged at block 310, the procedure returns to block 308 to continue transmitting data to the destination device. However, if receipt of the data is not acknowledged at block 310, the procedure continues to block 312 where the selected cooperating device retransmits the data to the destination device using a second encoding technique. In an alternative embodiment, the selected cooperating device may employ the first encoding technique that was used by the source device. The selected cooperating device is able to quickly retransmit the data to the destination device because the cooperating device monitored the previous failed transmission. This monitoring of the source device includes receiving and storing data transmissions from the source device. The selected cooperating device can immediately retransmit the data to the destination device without waiting for instructions from the source device.

Procedure 300 then returns to block 310 to determine whether the retransmitted data was received by the destination device. When data is accurately received by the destination device, the destination device processes the received data, as needed, to generate the proper data output. The use of two different encoding techniques has the advantage of providing additional coding gain in the communication environment. For example, first and second encoding techniques could be based on the use of the same convolutional code at both source device and cooperating devices, while each device uses a different interleaver at its convolutional encoder output. Encoder embodiments also include block codes, Turbo codes and various kinds of convolutional codes.

In an alternate embodiment, the procedure for communicating data between two devices is performed by the destination device instead of the source device as discussed above. In this embodiment, the destination device determines which of several available cooperating devices has the preferred connection to the source device. The selected cooperating device is granted authorization by the destination device such that the selected cooperating device begins monitoring data communications directed to the destination device. The selected cooperating device also stores certain data transmitted by the source device. If the destination device does not receive a certain data communication, the selected cooperating device can retransmit the data it received from the source device to the destination device.

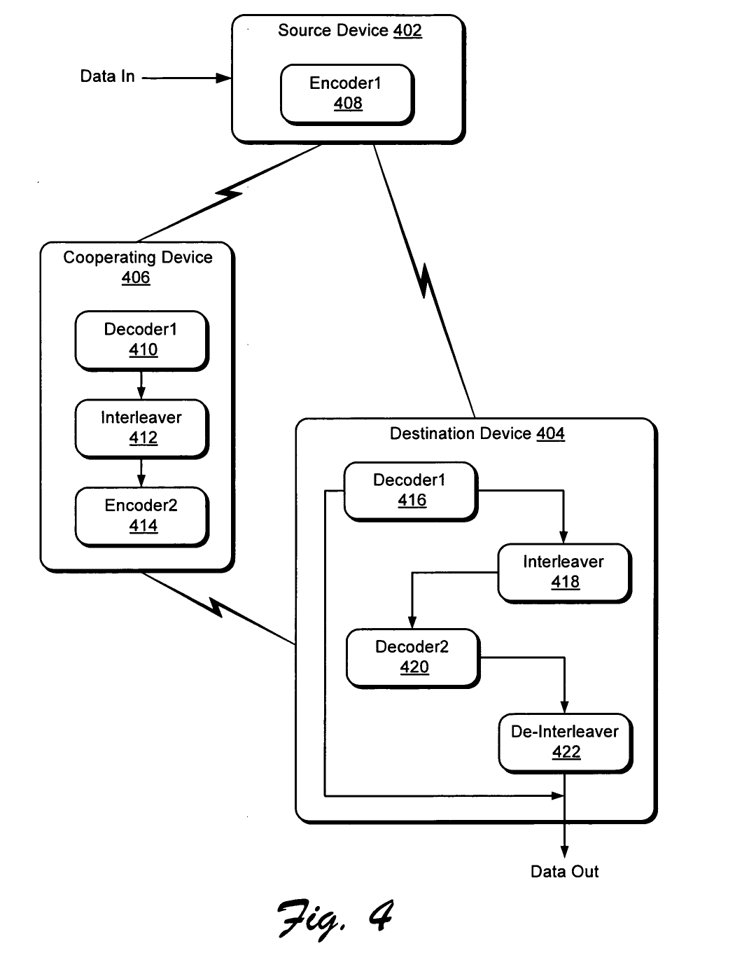

FIG. 4 is an illustration of an example environment containing a source device 402, a destination device 404, and a cooperating device 406. Source device 402 includes a first encoder 408 that encodes signals transmitted by source device 402, such as “Data In” received by the source device. Destination device 404 includes two decoders 416 and 420. Decoder 416 decodes data received directly from source device 402, which was encoded using a first encoder 408. Decoder 420 decodes data received from cooperating device 406, which was encoded using a second encoder 414. The output of decoder 416 produces “Data Out”, which is a copy of “Data In” provided to source device 402. The output of decoder 416 is also provided to interleaver 418 (identical to interleaver 412 at the cooperating device 406), the output of which is provided to decoder 420. The output of decoder 420 is processed by a de-interleaver 422 to produce “Data Out”. In one embodiment, the same encoder may be present at source device 402 and cooperating device 406, in which case encoder 408 and encoder 414 are identical. In this case, decoder 420 may not be present at destination device 404. In an alternate embodiment, destination device 404 performs iterative decoding by simultaneously using both decoders 416 and 420, where the output of decoder 420 is passed through de-interleaver 422 before entering decoder 416 and the output of decoder 416 is passed through interleaver 418 before entering decoder 420. After a pre-specified amount of processing of data by decoders 416 and 420, the iterative decoding procedure produces “Data Out”.

In some embodiments, cooperating device 406 includes a first decoder 410 to decode signals received from source device 402. Cooperating device 406 also includes an interleaver 412 to interleave the decoded signals and second encoder 414 that encodes the interleaved signals prior to communicating the data to destination device 404.

The manner in which data is communicated from source device 402 to destination device 404 is similar to procedure 300 discussed above with respect to FIG. 3. For example, source device 402 identifies cooperating device 406 as the cooperating device having the preferred connection to destination device 404 from the group of available cooperating devices. Source device 402 then grants authorization to cooperating device 406. When cooperating device 406 is granted this authorization, cooperating device 406 begins monitoring data transmissions by source device 402.

Source device 402 then transmits data to destination device 404 using a first encoding technique. If destination device 404 acknowledges receipt of the transmitted data, then source device 402 continues transmitting data. However, if destination device 404 does not acknowledge receipt of the transmitted data, then cooperating device 406 retransmits the data to destination device 404 using a second encoding technique which, in some embodiments, could be identical to the first encoding technique. When data is accurately received by destination device 404, the destination device decodes the data using the appropriate decoder 416 or 420, and performs any other necessary processing (e.g., de-interleaving and interleaving the data) to generate the proper data output.

As discussed herein, various cooperating devices are useful in retransmitting data that was erroneously received from the source device. Additional embodiments are discussed below for retransmitting data. Various automatic repeat request (ARQ) methods and Hybrid ARQ (HARQ) methods are available to handle such retransmission of data. Additionally, in wireless communications, adaptive mechanisms are useful to adjust transmission parameters to the momentary communication link quality which fluctuates due to fading and interference. The goal of adaptive modulation and coding (AMC) is to select the data block size and code rate in order to maximize throughput given the link state under some constraints such as the quality of service. The cooperative HARQ embodiments discussed below use HARQ in conjunction with AMC strategies. The AMC process results in decisions on the initial data block size and code rate based on some channel quality indicator (CQI) metric. Cooperative HARQ can be used with many existing traditional ARQ and HARQ schemes combined with AMC mechanisms, as discussed below.

Type I Cooperative HARQ

In this embodiment, the destination device discards the frame of data upon erroneous reception (i.e., when errors remain after decoding) and it asks for an entirely new retransmission. There is no combining of earlier and later versions of the frame, each one is standalone. After the source device's transmission, due to its proximity to the source, the cooperating device will successfully decode the transmitted signal with high probability. In case neither the source device nor the cooperating device receives the message successfully, both send NACK messages and the source device retransmits. If the cooperating device sends an ACK while the destination sends out a NACK, then the retransmissions are performed by the selected cooperating device until the packet is correctly received or a preset number of retransmissions have taken place, or until a delay constraint has been exceeded. This method does not require buffering of the corrupted packets at the destination device for later decoding since only the correctly received data that has not already been sent to the upper layers is stored in the memory. Therefore, this scheme is relatively simple to implement. However, once the coding rate is chosen, all the parity bits for error correction are transmitted even if they are not all needed, thereby reducing the channel use efficiency. This scheme can be implemented along with an AMC mechanism, which takes place independently across the source-destination and cooperating-destination links. In other words, the source device and the cooperating device adapt their code rates and modulation sizes to the channel variations independently based on their individual CQIs. It is assumed that the AMC is based on some CQI metric and thus the code rate and data block size remain the same as long as the channel remains fixed (e.g., slow-fading) during successive retransmissions of the frame.

Type II Cooperative HARQ with Incremental Redundancy (IR)

In this embodiment, another form of HARQ, called incremental redundancy (HARQ Type II), is utilized. In this embodiment, information bits are encoded by a low rate mother code. Each time, information and a selected number of parity bits are transmitted. Thus, instead of sending simple repeats of the coded data packet, progressive parity packets are sent in each subsequent retransmission of the packet following decoding failures. If a retransmission is not successful, the source device sends additional selected parity bits and the destination device puts together the new bits with those previously received. Thus, each retransmission produces a codeword of a stronger code. The family of codes is obtained by puncturing the mother code. The goal of IR is to allow the effective code rate to be gradually lowered until the packet can be successfully decoded. HARQ with IR makes use of rate compatible punctured codes (RCPC).

In a particular embodiment, this framework is extended to a cooperative HARQ protocol in a transmit cluster. The operation of the cooperative IR strategy with RCPC is as follows. The codeword C₀ of rate R₀ obtained by the initial encoding of the packet is punctured to obtain a set of codewords Cᵢ of rates Rᵢ, i=1, . . . , I, where the puncturing matrices are chosen such that the coded bits of Cᵢ are included in Cⱼ provided that Rᵢ>Rⱼ. First, the source terminal transmits the highest code rate Rₗ. The cooperating device and destination device informs the source device about the reliability of their reception by sending out ACK/NACK messages. Due to its high proximity, the cooperating device is expected to successfully decode the frame at this rate and thus send out an ACK message, while the destination device may not succeed in correctly decoding the message and may send a NACK message. If the transmission fails to both the cooperating device and the destination device, the next lower code rate Rₗ₋₁ is obtained by sending only the coded bits which differ in Cₗ and Cₗ₋₁ and the retransmission is performed by the source device. If the cooperating device receives the source device's initial transmission successfully, then it can retransmit the highest code rate Rₗ. The cooperating device may use different forward error correction (FEC) codes and different puncturing mechanisms to retransmit the frame.

At this point, in the event of failure of decoding at the destination, the retransmissions are performed by the cooperating device, which enjoys a better channel to the destination device than the source device. With each retransmission, additional punctured bits are transmitted. Retransmissions continue until all the coded bits of codeword C₀ are received. The procedure can be restarted if C₀ cannot be decoded. At any point, the procedure can be interrupted in case of successful decoding or if a delay constraint is exceeded. An AMC mechanism can be employed to leverage the cooperative IR performance by the determination of the initial code rate R₀ according to CQI feedback, as discussed earlier for Type I Cooperative HARQ scheme.

Type III Cooperative HARQ with Code Combining

In this embodiment, the destination device stores the previously received erroneous packets and combines them with the retransmitted packets to yield better decoding performance. Additionally, the information from different packets can be weighted according to an estimated transmission reliability. These techniques may be referred to as “code combining” or “chase combining”. In the following cooperative HARQ-based packet combining scheme, received packets from the source device and selected packets from the cooperating device are combined at the destination device by adding the demodulated log-likelihood values. This technique is applicable with any encoder block using recursive systematic convolutional (RSC) codes, block codes, turbo codes, or other codes that can be decoded using soft-input soft-output (SISO) decoders. Turbo coding refers to parallel concatenation of recursive systematic convolutional (RSC) codes, in which the data sequence is first encoded by an RSC encoder, then permuted using a pseudorandom interleaver and encoded by an identical RSC encoder. The systematic output, along with the parity outputs of the two RSC encoders are transmitted over the channel.

The decoder consists of many identical stages of SISO decoding modules. In one embodiment, the SISO decoder is based on the maximum aposteriori (MAP) algorithm. In particular, the log-likelihood ratio (LLR) output of the MAP decoder for each bit can be represented as the sum of LLR contributions due to systematic bits, parity bits, and extrinsic information. During decoding, LLRs of extrinsic information is exchanged among the SISO decoders. In cooperative HARQ with code combining, the destination device uses the LLRs generated by the decoder during a previous transmission as apriori information when decoding new transmissions. After the source device's transmission of the packet, if a NACK message is received from the destination device (assuming that the cooperating device successfully decodes), the data sequence is interleaved using a pseudorandom interleaver by the cooperating device and then encoded by a RSC/Turbo/block encoder and retransmitted. If the source device and cooperating devices use Turbo codes, the pseudorandom interleaver used by the cooperating device should be different from that used within the Turbo encoders. This helps in improving the performance by permuting input sequences that produce low output weight sequences during the source device's transmission so that the output weight during retransmissions is higher.

At this point, the prior transmission and the retransmission can be effectively combined at the destination device. During each additional retransmission, should it be necessary, a different pseudorandom interleaving pattern can be used by the cooperating device. The decoder structure is similar to a Turbo decoder, with a few modifications. Whenever the packet is deemed to be in error, a negative ACK is sent and the LLRs of each bit are stored. When a retransmission is received, these LLRs are used as apriori information during the decoding of the packet. Typically, at the beginning of iterative decoding, there is no apriori information and the LLRs of each bit are set to zero. This can be done because the apriori information was generated from a previous transmission and is uncorrelated with the extrinsic information generated by the component SISO decoders themselves. Note that in terms of storage complexity, only the LLRs corresponding to the previous transmission need to be stored.

Finally, it should be noted that when the source device and the cooperating device use the same code and operate at the same rate (no AMC, open-loop transmission) and no interleaving is carried out at the cooperating device, the combining at the destination device can be done according to maximum ratio combining (MRC) of the soft signal observations, before the LLR computations take place. Furthermore, when the source device and the cooperating device use the same code and no interleaving is carried out at the cooperating device, the soft-combining can be done at the destination device by summing the stored LLRs from the previous (source) transmission and the new LLRs obtained from cooperating device retransmission(s).

The embodiments described herein enhance the performance of currently used traditional HARQ mechanisms in time/frequency diversity-limited (e.g., slow, flat fading) propagation environments, where HARQ-based frame repetition may not be sufficient to improve link reliability when the channel is in a deep fade, since poor channel conditions are likely to be experienced by the initially-sent as well as repeated frame transmissions. By using another closely-located cooperating device to perform retransmissions, the proposed cooperative HARQ scheme ensures that signal retransmissions take place over a higher-quality channel, reducing the expected number of retransmissions, improving system throughput, and maintaining full compatibility with existing multiple-access techniques.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method implemented by a source device, the method comprising:
identifying a plurality of available cooperating devices associated with the source device;
selecting one of the available cooperating devices has a preferred connection to a destination device among the available cooperating devices;
transmitting data to the destination device; and
authorizing the selected cooperating device to retransmit the data to the destination device if the destination device fails to acknowledge receipt of the data transmitted from the source device.

2. A method as described in claim 1, wherein the available cooperating device is selected, at least in part, based on an expected transmission time between the cooperating device and the destination device that is less than an expected transmission time of one or more other said available cooperating devices.

3. A method as described in claim 2, wherein the expected transmission time is calculated as a reciprocal of an expected throughput on a given communication link between a transmitting device and a receiving device.

4. A method as described in claim 1, wherein authorizing the selected cooperating device to retransmit the data to the destination device permits the selected cooperating device to retransmit the data without further instruction by the source device.

5. One or more computer-readable media comprising processor-executable instructions that, when executed, direct a processor contained in a source device to:
establish a wireless connection between the source device and a destination device;
identify a plurality of available cooperating devices associated with the source device, wherein each of the available cooperating devices has established a wireless connection to the destination device;
determine a quality associated with each of the wireless connections between the available cooperating devices and the destination device;
select the cooperating device having the highest quality wireless connection with the destination device;
transmit data from the source device to the destination device; and
authorize the selected cooperating device to retransmit the data to the destination device if the destination device fails to acknowledge receipt of the data transmitted from the source device.

6. One or more computer-readable media as described in claim 5, wherein the quality associated with each of the wireless connections is determined based on an expected transmission time associated with each of the wireless connections.

7. One or more computer-readable media as described in claim 5, wherein the selected cooperating device is selected, at least in part, based on an expected transmission time between the cooperating device and the destination device that is less than an expected transmission time of one or more other said available cooperating devices.

8. One or more computer-readable media as described in claim 5, wherein data transmitted from the source device to the destination device is encoded using a first encoding technique.

9. One or more computer-readable media as described in claim 5, wherein data transmitted from the source device to the destination device is encoded using a first encoding technique.

10. One or more computer-readable media as described in claim 5, wherein data transmitted from the selected cooperating device to the destination device is encoded using a first encoding technique.

11. One or more computer-readable media as described in claim 5, wherein the data transmitted from the source device to the destination device is encoded using a first encoding technique and data transmitted from the selected cooperating device to the destination device is encoded using a second encoding technique.

12. One or more computer-readable media as described in claim 5, wherein:
wherein the data transmitted from the source device to the destination device is encoded using a first encoding technique; and
wherein the data transmitted from the selected cooperating device to the destination device is encoded using the first encoding technique.

13. One or more computer-readable media as described in claim 5, wherein the selected cooperating device is authorized to retransmit data without further instruction by the source device.

14. An apparatus comprising:
a communication module; and
a processor to couple to the communication module and configured to communicate with a number of cooperating devices, each of which is to communication with a destination device, the processor further configured to establish a wireless connection between the apparatus and the destination device and to select one of the cooperating devices to retransmit data to the destination device when an acknowledgment is not received, and wherein the processor is to select one of the cooperating devices by determining which cooperating device has a preferred wireless connection with the destination device.

15. An apparatus as described in claim 14, wherein the communication module includes a dipole antenna.

16. An apparatus as described in claim 14, wherein the data transmitted from the apparatus to the destination device is encoded using a first encoding technique and retransmitted data from the selected cooperating device to the destination device is encoded using the first encoding technique.

17. An apparatus as described in claim 14, wherein the processor is to select one of the cooperating devices by associating an expected transmission time metric with each cooperating device, otherwise the processor is to select no cooperating device if the wireless connection between the apparatus and the destination device has a smallest expected transmission time metric than the cooperating devices; and
selecting a cooperating device having the smallest associated expected transmission time metric if the smallest expected transmission time metric is less than the expected transmission time metric associated with the wireless connection between the apparatus and the destination device.

18. An apparatus as described in claim 14, wherein the processor is further configured to instruct the selected cooperating device to automatically retransmit data to the destination device upon determining that the data transmission from the apparatus to the destination device failed.

19. An apparatus comprising:
a communication module; and
a processor to couple to the communication module and configured to establish a wireless connection with a destination device, identify a plurality of available cooperating devices that have established a wireless connection to the destination device, determine a quality associated with each of the wireless connections; select a particular said cooperating device with a respective said wireless connection that has a higher quality that other said wireless connections, transmit data to the destination device, and authorize the selected cooperating device to retransmit the data to the destination device if the destination device fails to acknowledge receipt of the transmitted data.

20. An apparatus as described in claim 19, wherein the communication module includes a plurality of antennas.

21. An apparatus as described in claim 19, wherein the quality associated with each of the wireless connections is determined based on an expected transmission time associated with each of the wireless connections.

22. An apparatus as described in claim 19, wherein the selected cooperating device is selected, at least in part, based on an expected transmission time between the cooperating device and the destination device that is less than an expected transmission time of one or more other said available cooperating devices.

23. An apparatus as described in claim 19, wherein the transmitted data is encoded using a first encoding technique.

24. An apparatus as described in claim 19, wherein the selected cooperating device is authorized to retransmit data without further instruction from the processor.
